(19) United States
(12) Patent Application Publication
(10) Pub. No.: US 2003/0045413 A1
(43) Pub. Date: Mar. 6, 2003

(54) Roller assembly with bushing

(76) Inventors: Garett Gillen, Tecumseh, MI (US); Daniel Sileo, Saline, MI (US)

Correspondence Address: Marshall & Melhorn, LLC, 8th Floor, Four SeaGate, Toledo, OH, 43604, US

(21) Appl. No.: 10/214,538

(22) Filed: Aug. 8, 2002

Related U.S. Application Data
(60) Provisional application No. 60/317,641, filed on Sep. 6, 2001.

(51) Int. Cl. B25F 5/02; F16C 13/00

(52) U.S. Cl. 492/47; 492/58

(57) ABSTRACT

A roller assembly has at least one bushing for preventing the longitudinal movement of an end cap and its associated bearing housing along an axle. One end of the bushing is located in an abutting relationship with the bearing housing. The bushing is secured to the axle and placed in contact with the bearing housing which is secured within the end cap. By preventing longitudinal movement of the bearing housing, longitudinal movement of the end cap is thereby prevented.

### RELATED APPLICATION

This application is claiming the benefit, under 35 U.S.C. §119(e), of the provisional application filed Sep. 6, 2001, under 35 U.S.C. §111(b), which was granted Serial No. 60/317,641, and is hereby incorporated by reference.

### BACKGROUND OF THE INVENTION

1. Field of the Invention

The present invention relates to a roller assembly for endless belt systems. More particularly, the present invention relates to a roller assembly for an endless belt system such as an exercise treadmill or a conveyor belt.

2. Summary of the Related Art

Roller assemblies are commonly used in many industries to support endless belts or conveyors. In general, a roller assembly has a tube which has a bearing housing in each end thereof. Each bearing housing is rotatably journaled on an axle that extends longitudinally through the tube. Often, the bearing housing is located in a plastic bearing end cap onto which the tube maybe crimped. Typically, a plurality of such assemblies are mounted adjacent one another in a frame such as in an exercise treadmill or a conveyor belt system.

In their simplest form, exercise treadmills or conveyor belt systems include an endless belt that moves over an underlying support composed of a plurality of roller assemblies such as those described above. The roller assemblies could be such as shown in U.S. Pat. Nos. 4,974,831 and 4,342,452 each of which is hereby incorporated by reference. The belt may be powered manually or by a motor.

The axle protrudes from each end of the roller tube and engages the frame. Frequently, the axle not only serves to mount the tube but also functions as a structural element of the roller assembly. In such cases, the ends of the axle are drilled and tapped. Bolts are located in the tapped holes to secure the roller and the frame together.

A serious problem associated with the known roller assemblies is that the end caps are not securely located within the ends of the tube. Impact on the endless belt, such as that caused by exercising on a treadmill or locating articles on a conveyor belt, are transferred directly to the roller assemblies. With time, such impact may cause the end caps to loosen from the ends of the roller assemblies. Should the end caps come loose from the end of the assembly, it could result in the catastrophic failure of the conveyor or the treadmill.

Therefore, it would be advantageous to provide an improved means for securely locating the end caps to the roller assemblies to prevent the catastrophic failure of the conveyor or the treadmill.

### SUMMARY OF THE INVENTION

The present invention provides a roller assembly for maintaining the end caps of a conveyor belt roller, especially a treadmill roller, in a functioning position. The roller assembly has a generally cylindrical tube bounded by a first end and a second end. An axle extends longitudinally through the tube and protrudes from the first and second ends. A first and a second end cap are located in the first and second ends, respectively, of the tube. A bearing housing is fitted within each of the end caps. The bearing housing is in contact with the axle and acts to reduce friction between the tube and the axle as the tube rotates.

The portions of the axle extending from the ends of the tube are fitted with at least one bushing. The bushing is preferably a split ring bushing with one end located in an abutting relationship with the bearing housing. Longitudinal movement of the bushing is prevented by securing the bushing to the axle by a bolt, a post or other mechanical stop.

The bushing securely locates the bearing housing within the end cap. By preventing the longitudinal movement of the bearing housing, longitudinal movement of the end cap is thereby prevented.

The present invention preferably uses a split ring bushing as such bushings are readily and economically available in the industry. The present invention also secures the bushing to the axle to prevent, or reduce, rotation of the bushing. Preventing, or reducing, the rotation of the bushing minimizes wear on the axle and other components of the roller assembly in contact with the bushing. Furthermore, preventing, or reducing, the rotation of the bushing reduces noise and vibration as the roller assembly rotates during operation.

### BRIEF DESCRIPTION OF THE DRAWINGS

The above, as well as other advantages of the present invention, will become readily apparent to those skilled in the art from the following detailed description of the preferred embodiment when considered in light of the accompanying drawings, in which:

FIG. 1 is a side view of an embodiment of the present invention;

FIG. 2 is a perspective view of a portion of the embodiment shown in FIG. 1;

FIG. 3 is an end view of a portion of the embodiment shown in FIG. 1;

FIG. 4 is a sectional view of the embodiment shown in FIG. 1;

FIG. 5 is a perspective view of an embodiment of the present invention;

FIG. 6 is a perspective view of an alterative embodiment of the present invention;

FIG. 7 is an alternative embodiment of the present invention;

FIG. 8 is an alternative embodiment of the present invention; and

FIG. 9 is an alternative embodiment of the present invention.

### DETAILED DESCRIPTION OF PREFERRED EMBODIMENTS

It is to be understood that the specific structures and processes illustrated in the attached drawings and described in the following detailed description are simply exemplary embodiments of the invention. Hence, specific dimensions and other physical characteristics relating to the embodiments disclosed herein should not be considered as limiting.

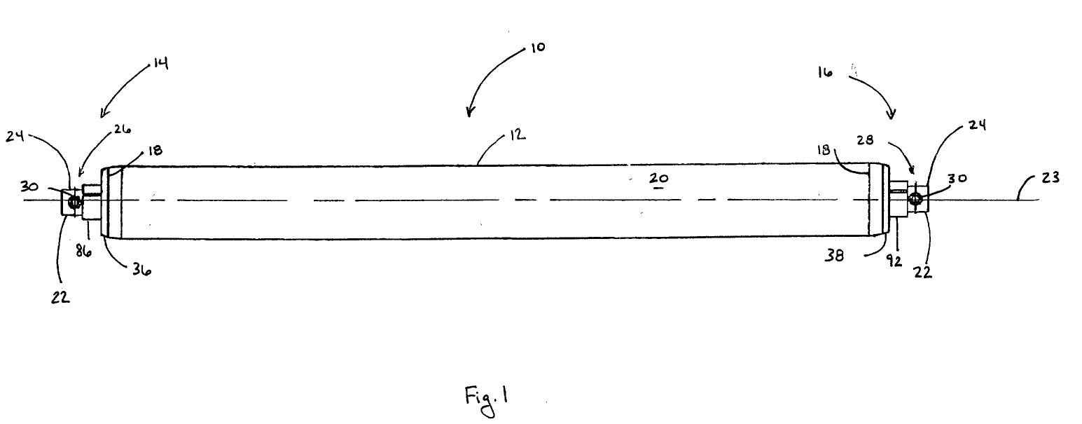

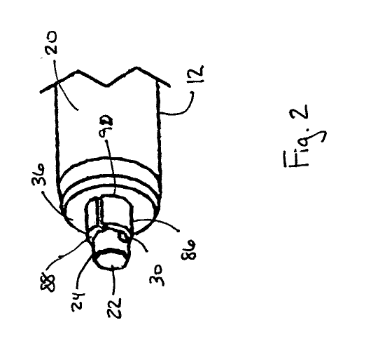

Referring now to the drawings, FIG. 1 depicts a roller assembly 10 having a tube 12 bounded by a first end portion 14 and a second end portion 16. The first 14 and second end 16 portions terminate in, and are substantially defined by, edges 18. The tube 12 is generally cylindrical in shape having a substantially smooth outside surface 20. The tube 12 may be constructed of steel, aluminum, their alloys, or other materials known to those skilled in the art.

An axle 22 preferably extends along a longitudinal axis 23 of the tube 12 and protrudes from the first 14 and second 16 end portions. The axle 22 is generally cylindrical in shape having a substantially smooth outside surface 24. The axle 22 is constructed of steel, or an alloy thereof, although other materials known to those skilled in the art are well within the scope of the present invention.

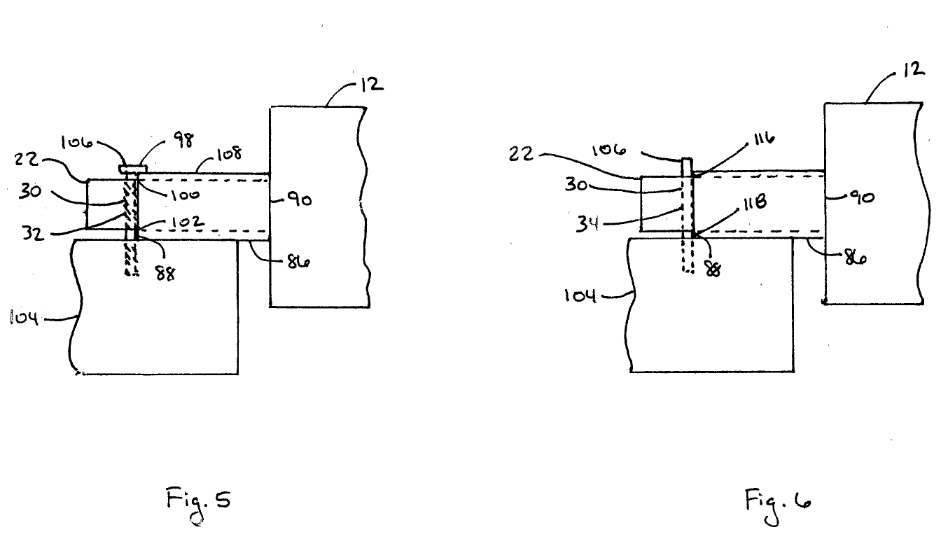

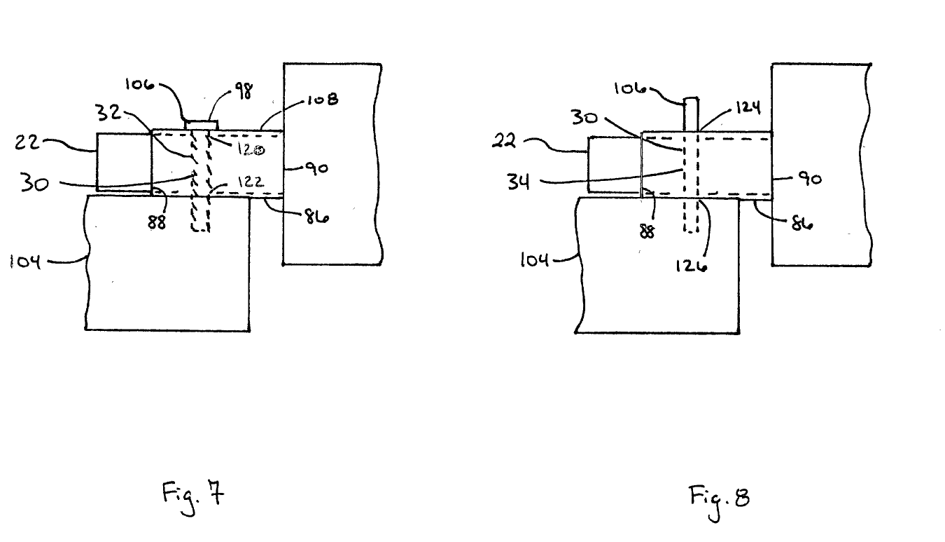

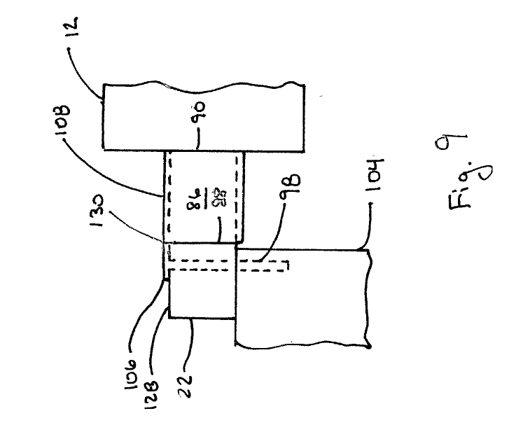

As seen in FIG. 1, a first portion 26 of the axle 22 extends from the first end portion 14 of the tube 12 and a second portion 28 of the axle 22 extends from the second end portion 16 of the tube 12. Preferably, at least one bore 30 is located in each of the first 26 and second 28 axle portions and extends completely through each portion 26, 28. In one embodiment, described below and depicted in FIGS. 5 and 7, the bores 30 are tapped 32. However, in an alternative embodiment, also described below and depicted in FIGS. 6 and 8, the bores 30 have a smooth internal surface 34.

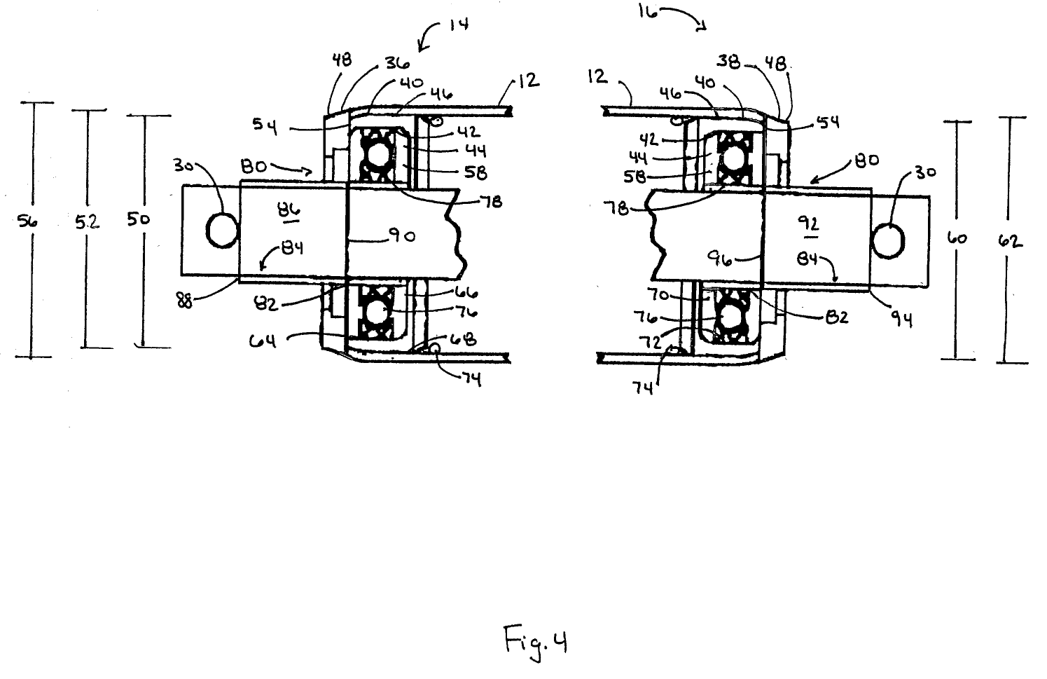

As shown in FIG. 1, a first 36 and a second 38 end cap are located in the first 14 and second 16 end portions, respectively, of the tube 12. The end caps 36, 38 are substantially circular to fit within the cylindrical tube 12. As shown in FIG. 4, the end caps 36, 38 have an outer wall 40, an inner wall 42 and a cavity 44. The outer wall 40 has an inner portion 46 and an outer portion 48. The inner portion 46 has an outside diameter 50 less than an inside diameter 52 of the tube 12. A transition 54 between the inner portion 46 and the outer portion 48 increases an outside diameter 36 of the outer portion 48 to a diameter 56 greater than the outside diameter 50 of inner portion 46.

In a preferred embodiment, the end caps 36, 38 are constructed of molded plastic, however, those skilled in the art will recognized that the end caps 36, 38 may be constructed of other materials without departing from the scope or spirit of the invention.

A bearing housing 58 has an outside diameter 60 slightly smaller than a diameter 62 of an inner surface 64 of an end cap 36, 38. A first bearing housing 66 is located adjacent an inner surface 68 of the first end cap 36 and a second bearing housing 70 is located adjacent an inner surface 72 of the second end cap 38. In a preferred embodiment, each bearing housing 66, 70 is frictionally located adjacent the inner surface 68, 72 of each end cap 36, 38. In a more preferred embodiment, each bearing housing 66, 70 is secured into each end cap 36, 38 by at least one circumferential ring 74 integrally formed with the inner surface 68, 72 of each end cap 36, 38, as shown in FIG. 4.

The bearing housings 66, 70 house bearings 76. The bearings 76 may preferably be a metal ball type as known by those skilled in the art. It should also be understood that the present invention will work equally well with other friction reducing devices known in the art.

As depicted in FIG. 4, each bearing housing 66, 70 has a circular cavity 78 proximate a central position 80 of the housing 58. The bearing housing 58 is located within an end cap 36, 38 and the cavity 78 of the bearing housing 58 substantially aligns with the cavity 44 of the end cap 36, 38. In this orientation, a passageway 82 is provided for the axle 22 to pass through.

The first end cap 36, having the first bearing housing 66 located therein, is located within the first end portion 14 of the tube 12 and the second end cap 38, having the second bearing housing 70 located therein, is located within the second end portion 16 of the tube 12, as shown in FIGS. 1 and 4. In a preferred embodiment, the first and second end portions 14, 16 of the tube 12 are crimped, or otherwise secured, adjacent the inner portion 46 of the outer wall 40 of each end cap 36, 38. In a more preferred embodiment depicted in FIG. 4, the edges 18 of the first 14 and second 16 end portions of the tube 12 are placed in an abutting relationship with the transition 54 between the inner 46 and outer 48 portions of the outer wall 40, and then the end portions 14, 16 are crimped. Locating the edges 18 of the tube 12 in this orientation assists to keep the end caps 36, 38 from traveling into or out of the tube 12.

Locating the axle 22 within the cavities 44 of both bearing housings 66, 70 and the end caps 36, 38 described above and locating that combination within the tube 12 greatly reduces the friction between the tube 12 and the axle 22 as the tube 12 rotates.

In a preferred embodiment depicted in FIG. 1, at least one bushing 84 is located on the axle 22 adjacent the first bearing housing 66 and at least one bushing 84 is located on the axle 22 adjacent the second bearing housing 70. In a more preferred embodiment, a first bushing 86, having a first edge 88 and a second edge 90, is located on the axle 22 such that either the first edge 88 or the second edge 90 is substantially in an abutting relationship with the first bearing housing 66. Similarly, a second bushing 92, having a first 94 and a second 96 edge, is located on the axle 22 such that either the first edge 94 or the second edge 96 is substantially in an abutting relationship with the second bearing housing 70.

In one preferred embodiment, each bushing 86, 92 is secured to the axle 22 by placing the edge of the bushing 86, 92, which is opposite the edge in an abutting relationship with the bearing housing 66, 70, in an abutting relationship with at least one securing means.

Preferably, the securing means is a metal shaft located in the above-mentioned bore 30. The metal shaft may be such as a threaded bolt 98 located in the bore 30 as depicted in FIG. 5. Preferably, the entire bolt 98 passes through the bore 30 and contacts the bushing 84 at a first location 100 and a second location 102. As the bolt 98 passes straight through the axle 22, the second location 102 will be approximately 180 degrees from the first location 100.

As shown in FIG. 5, the bolt 98 also attaches the axle 22 to a frame 104, as known by those skilled in the art for treadmills or conveyor belts. In an alternative embodiment, the securing means may be an upstanding pin 106 secured to the frame 104, as shown in FIG. 6. The bore 30 is located on the pin 106 thereby securing the roller assembly 10 to the frame 104. Preferably, the entire pin 106 passes through the bore 30 and contacts the bushing 84 at a first location 116 and a second location 118.

In yet another embodiment, the securing means may be located within the bushing 84. For example, the securing means may be such as a bolt 98, as depicted in FIG. 7, which extends through the bushing 86, 92 between the first 88, 94 and second edges 90, 96 of the bushing 86, 92. The bolt 98 contacts the bushing 86, 92 at a third 120 and forth 122 location.

Alternatively, the securing means may be a pin 106, depicted in FIG. 8, which extends through the bushing 98, 92 between the first 88, 94 and second edges 90, 96 of the bushing 86, 92. The pin 106 contacts the bushing at a third 124 and fourth 126 location.

In yet another embodiment depicted in FIG. 9, the bolt 98 is located in the axle 22 such that the head of the bolt 106 substantially contacts an outside surface 128 of the axle 22. The bolt 98 is located in the axle 22 such that a side surface 130 of the bolt head 106 is located in an abutting relationship with the first edge 88, 94 of the bushing 86, 92.

In each of the above-described embodiments, the securing means prevents, or reduces, the longitudinal movement of the bushing 84 on the axle 22. Although the securing means has been described as a bolt or pin other mechanical stops known in the art may be used. With the securing means on one side of the bushing 84, and the bearing housing 66, 70 on the other side, the bearing housing 66, 70 is prevented from moving longitudinally. Further, as the bearing housing 66, 70 is securely located within the end cap 36, 38, the end cap 36, 38 are prevented from longitudinal movement with respect to the tube 12.

In a preferred embodiment, the securing means also prevents, or reduces, the rotation of the bushing 86, 92 on the axle 22. In the embodiment wherein a bolt 98 is the securing means and the bolt 98 is located adjacent an edge 88, 94 of the bushing 86, 92, the head 106 of the bolt 98 is located against an outside surface 108 of the bushing 86, 92, as depicted in FIG. 5. The head 106 of the bolt 98 frictionally engages with the outside surface 108 of the bushing 86, 92 and secures the bushing 86, 92 in a non-rotatable orientation. In the embodiment wherein the securing means is located within the bushing 86, 92, as depicted in FIGS. 7 and 8, the securing means, by virtue of its location actually within the bushing 86, 92 and the axle 22, prevents, or reduces the rotation of the bushing 86, 92.

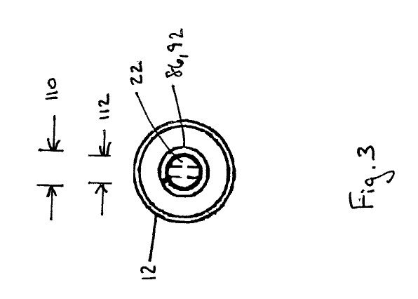

As shown in FIG. 3, the bushing 86, 92 has an inside diameter 110 that is slightly larger than the outside diameter 112 of the axle 22. The inside diameter 110 of the bushing 86, 92 is designed to allow the bushing 86, 92 to slidably fit on the axle 22. The outside diameter 114 of the bushing 86, 92 may be of any design known in the art as long as it does not interfere with the rotation of the end cap 36, 38 and the tube 12.

Preferably, the bushing 86, 92 is a split ring bushing, although solid ring bushings or other bushing designs known in the art are within the scope of the present invention.

The bushing 86, 92 is constructed of a steel alloy, although bushings 86, 92 constructed from plastic, nylon or other materials known in the art are well within the scope of this invention.

In accordance with the provisions of the patent statutes, the present invention has been described in what is considered to represent its preferred embodiment, however, it should be noted that the invention can be practiced otherwise than as specifically illustrated and described without departing from its scope or spirit.

What is claimed is:

1. A roller assembly, comprising:
a. a tube having a first end and a second end, said first end having a first end cap mounted therein and said second end having a second end cap mounted therein;
b. a first friction reducing device secured within said first end cap and a second friction reducing device secured within said end cap;
c. an axle having a first end and a second end, said ends extending through said first and said second friction reducing devices, respectively; and
d. at least one bushing mounted on each end of said axle to reduce or prevent longitudinal movement of said first and said second end caps relative to said tube.

2. The roller assembly of claim 1, wherein said first end and said second end of said tube terminate in a first and a second edge portion, respectively.

3. The roller assembly of claim 1, wherein said tube is comprised of steel.

4. The roller assembly of claim 1, wherein said tube is comprised of an aluminum alloy.

5. The roller assembly of claim 1, wherein said axle extends along a longitudinal axis of said tube.

6. The roller assembly of claim 1, wherein said axle is comprised of steel.

7. The roller assembly of claim 1, wherein said axle is comprised of an aluminum alloy.

8. The roller assembly of claim 1, wherein a first portion of said axle extends from said first end and a second portion of said axle extends from said second end of said tube.

9. The roller assembly of claim 8, wherein at least one bore is located in each of said first portion of said axle and said second portion of said axle.

10. The roller assembly of claim 9, wherein said at least one bore is threaded.

11. The roller assembly of claim 9, wherein said at least one bore has a smooth internal surface.

12. The roller assembly of claim 2, wherein said first and said second end caps each have an outer wall, an inner wall and a cavity.

13. The roller assembly of claim 12, wherein each of said outer walls has an inner portion and an outer portion.

14. The roller assembly of claim 13, wherein each of said inner portions of said outer walls has an outside diameter less than an inside diameter of said tube.

15. The roller assembly of claim 13, wherein each of said outer portions of said outer walls has an outside diameter greater than said outside diameter of said inner portion.

16. The roller assembly of claim 13, wherein a transition portion is located between each of said outer portions and each of said inner portions on each of said outer walls.

17. The roller assembly of claim 16, wherein said first and said second edge portions of said tube abut said first and second transition portions, respectively.

18. The roller assembly of claim 17, wherein contact between said first and second edge portions with said first and second transition portions, respectively, prevents said end caps from longitudinal movement within said tube.

19. The roller assembly of claim 18, wherein a first bearing housing is located adjacent said inner wall of said first end cap and a second bearing housing is located adjacent said inner wall of said second end cap.

20. The roller assembly of claim 19, wherein said first end cap has at least one circumferential ring integrally formed with said inner wall thereof for securing said first bearing housing therein.

21. The roller assembly of claim 19, wherein said second end cap has at least one circumferential ring integrally formed with said inner wall thereof for securing said second bearing housing therein.

22. The roller assembly of claim 19, wherein said first and said second bearing housings each have a centrally located cavity and each of said bearing housing cavities align with said first and said second end cap cavities respectively within said tube to provide a passageway for said axle to pass through.

23. The roller assembly of claim 22, wherein said first and said second end portions of said tube are secured adjacent said inner portions and said transitions of each of said outer walls of said first and said second end caps, respectively.

24. The roller assembly of claim 23, wherein at least one bushing is located on said axle in an abutting relationship with said first bearing housing and at least one bushing is located on said axle in an abutting relationship with said second bearing housing.

25. The roller assembly of claim 24, further comprising a securing means for preventing the longitudinal movement of said bushings.

26. The roller assembly of claim 25, wherein said securing means prevents the rotation of said bushings on said axle.

27. The roller assembly of claim 26, wherein said bushings are split ring bushings.

28. The roller assembly of claim 27, wherein contact between said bushings and said bearing housings prevents longitudinal movement of said housings and said end caps.

29. The roller assembly of claim 28, wherein said end caps are secured within said tube ends by said bushings and contact between said transitions and said tube edges.

30. A roller assembly, comprising:
a. a roller tube having a first end and a second end;
b. a first end cap located in said first end and a second end cap located in said end, respectively;
c. a first bearing housing mounted in said first end cap and a second bearing housing mounted in said second end cap;
d. a first portion of an axle extending through said first bearing housing and a second portion of said axle extending through said second bearing housing; and
e. at least one bushing secured to each of said first and said second axle portions, said bushings placed in contact with said first and said second bearing housings to prevent longitudinal movement thereof and thereby reduce or prevent longitudinal movement of said first and said second end caps relative to said tube.

31. A treadmill roller assembly, comprising:
a. a treadmill roller tube having a first end and a second end;
b. a first molded plastic end cap located within said first end and a second molded plastic end cap located within said second end;
c. a first bearing housing secured within said first end cap and a second bearing housing secured within said second end cap;
d. a first portion of an axle extending through said first bearing housing and a second portion of said axle extending through said second bearing housing; and
e. at least one split ring bushing mounted on each of said first and said second axle portions, said bushings located in an abutting relationship with said first and said second bearing housings to securely locate said end caps within each of said first and said second ends.
